(19) United States
(12) Patent Application Publication
(10) Pub. No.: US 2004/0003060 A1
(43) Pub. Date: Jan. 1, 2004

(54) Method and apparatus for network connection registration and selection

(75) Inventors: Junichi Asoh, Machida-shi (JP); Kazuo Fujii, Yokohama-shi (JP); Masahiko Hatori, Yamato-shi (JP); Masaharu Itoh, Yamato-shi (JP); Kozo Matsunaga, Sagamlhara-shi (JP); Shunya Uno, Fujisawa-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/185,611

(22) Filed: Jun. 28, 2002

(30) Foreign Application Priority Data
Jun. 28, 2002 (JP) 2001-214551

(51) Int. Cl. G06F 15/177

(52) U.S. Cl. 709/220

(57) ABSTRACT

A system is provided with a location profile for storing adapter information, which is physical change information corresponding to location information, and network configuration information, which is logical change information corresponding to this adapter information; an adapter changing device for changing an adapter to another according to the adapter information received from the location profile according to a specified location received from the user; and a network configuration updating device for updating a network configuration according to the network configuration information received from the location profile according to the received specified location.

### BACKGROUND OF THE INVENTION

1. Field of the Invention

The present invention relates to a computer, etc. enabled to communicate with external, more particularly to a computer, etc. connected to a plurality of networks.

2. Background of the Art

Computers such as notebook personal computers (notebook PCs) are enabled to be connected via such networks as LAN (Local Area Network), etc., via interface devices referred to as NICs (Network Interface Cards), LAN adapters, and the like. Early on, the mainstream of the interface devices connected to those networks was modems at first; now, there are such wired communication adapters as token-ring adapters, Ethernet® adapters, and similar. In the future, it is expected that the mainstream interface devices will be wireless LAN and other wireless type adapters. Usually, LAN adapters are installed in notebook PCs so that new and old versions may co-exist therein so as to keep the compatibility options available. As a result, many notebook PCs now use a plurality of interface devices.

When a computer is provided with a plurality of interface devices, the computer can often be connected to many networks by various methods. On the other hand, the user of the computer is also often required to change an interface device from a first device to second device (i.e., from one to another) each time a network connection is changed. In particular, this required change is too often needed when the subject notebook PC is physically being moved during an operation.

Once moved, in order to connect the PC to a network at a particular place(s) to which the PC has been moved to, a usable interface device must be selected and the network configuration must be appropriately setup for the selected interface device at each of the selected locations (i.e., places). To date, there is no available method for setting up a device manager, a network configuration, etc., automatically for an operating system such as Windows^{ò} (Microsoft Corp.) but rather a user must manually configure the set up for a device manager, a network configuration, etc., one by one, individually, methodically and in detail.

As is known, conventional operating systems at present do not provide the capability to specify a network adapter explicitly via which the PC may be connected to a network while there is a plurality of usable network adapters in the system. In other words, the conventional operating system cannot be used to specify selection and connection of a network, since the conventional operating system is intended for desk-top PCs that are fixed at a location, typically where they are installed. This is why the conventional systems have been required to change a network adapter from one to another using physical means, for example, disconnecting the network adapter and/or network cable so as to specify another network connection.

Furthermore, to date, the conventional operating systems have enabled the network adapter to be registered for only one network.

More particularly, just like the mobile specifications of operating systems to be installed in notebook PCs, when one network adapter is commonly used both at an office and at home, when the network configuration differs between the use at the office and the use at home, the network configuration must be updated for each network connection. In addition, it is often difficult to accurately setup the configuration, especially for beginner users. Similarly, now that such new connecting methods as wireless network, VPN (Virtual Private Network), broadband, etc., continue to appear one after another, it is readily foreseeable that the network connection is becoming more difficult for users, and especially beginners.

The present complexities in the environment are not what was envisioned by PC makers who have wished to provide users with machines that are easier to operate. As a result, this is a basis for reasoning that the present standards do not support wireless networks to disconnecting network cables physically and physically removing built-in network adapters.

### SUMMARY OF THE INVENTION

Therefore, from the aforementioned problems above, it is an object of the present invention to provide a method for changing a network connection to another network connection in a system that employs a plurality of network adapters so as to solve the above conventional technical problems.

In order to achieve the above object, the present invention provides a user-friendly network connection method that enables the user to select a predetermined object from a set of objects in which both physical and logical network configurations are collected for each network connection. In other words, the present invention provides a computer enabled to select a predetermined network connection so as to communicate externally with a system connected to a plurality of networks.

The computer comprises: a changing means for physically changing a network adapter to another in accordance with a predetermined network connection selected by the user from among a plurality of usable network adapters employed for the system; a setup means for setting up a logical network configuration corresponding to the selected network adapter; an identification information registering means for registering predetermined identification information when the logical network configuration is set up by the setup means; and a storing means for storing the information of the selected network adapter and the information of the logical network configuration so as to be related to the registered identification information.

The identification information registered by the identification information registering means, when it is location information related to a place where the computer is used, uniquely relates the location information to network connection information. This is a favorable point of the present invention, since the identification information is not network configuration information (which is often difficult to remember), but rather it is location information (which is more readily rememberable and usable so as to change a network connection from one to another).

For example, when a notebook PC (computer) is moved and used at both a home and in the office, the computer can be connected to each near-by network merely by clicking such a location name as “home”, “office”, or the like, according to a preferred embodiemtn of the present invention.

Additionally, in a preferred embodiemnt of the preent invention, the computer includes a connection request receiving means for receiving a network connection request from a user according to predetermined identification information; an adapter changing means for changing a network adapter to another according to the adapter information received from a data base in accordance with this predetermined identification information; a network configuration updating means for updating a network configuration according to the changed network adapter according to the network configuration information received from the database corresponding to the predetermined identification information; and an application executing means for executing an application program for the network adapter changed by the adapter changing means.

Furthermore, according to a further preferred embodiment of the present invention, a computer includes a database for storing adapter information, which is physical change information, as well as the network configuration information, which is logical change information corresponding to this adapter information in accordance with each of a plurality of network connections; a connection request receiving means for receiving a network connection request from the user; an adapter changing means for changing an adapter to another according to the adapter information received from the database in response to the received network connection request; and a network configuration updating means for updating a network configuration according to the network configuration information received from the database in response to the received network connection request.

The present invention enables both a physical adapter and a logical network configuration to be combined and changed together.

In an aspect of the present invention, the computer, when connected to, for example, a wireless LAN, comprises a device for storing a registered profile that includes network configuration setting-up information corresponding to a predetermined identifier; a scanning device for scanning such identifiers as network names (SSID), MAC addresses, etc. used to identify respective objects to be connected with the computer; and a network configuration setting-up device for reading a registered profile corresponding to the identifier resulting from the scanning by the scanning device from the storing means to set up a configuration of a network according to the information in the registered profile.

In this aspect, it is also preferable that the computer of the present invention further comprise a priority registering device for registering priority for each of the plurality of identifiers and the network configuration setting-up device, when a plurality of identifiers are obtained by the scanning device, selects a predetermined registered profile according to the priority registered by this priority registering device to set up a configuration of a network; thereby the user can set up a configuration of a network by selecting a desired access point of a wireless network in which a plurality of identifiers can be obtained at a time.

In another preferred embodiment, the computer of the present invention is provided with a generating device for generating information of a registered profile that includes an identifier used to connect a network, received, for example, from a user corresponding to location information that is identification information; a storing device for storing the registered profile information generated by this generating device; and a priority assigning device for assigning connection priority to a connectable network corresponding to the location information with use of the selected profile information.

From another point of view, the present invention may also be a portable information apparatus that is enabled to select a predetermined connected network so as to communicate externally with a system connected to a plurality of networks. The portable information apparatus is provided with a database for storing information of changeable network adapters and network configuration information corresponding to predetermined identification information respectively; a display device for displaying a list of identification information items stored in the data base; an input device for receiving a user's selection of specific identification information from the list displayed in the display device; and a network changing unit for reading both network adapter information and network configuration information from the data base according to the selected specific identification information received from the input device so as to update the network configuration.

Additionally, in a further preferred embodiment, the present invention provides a network connection registering method for enabling a computer to select a predetermined network connection so as to communicate externally with a system connected to a plurality of networks. The method comprises a step of receiving an input from the user with respect to location information related to a place where the computer is possibly used; a step of displaying a list of usable network adapters selected from a plurality of network adapters employed for the system; a step of receiving a user's selection of a network adapter usable in the location; a step of receiving an input of logical network configuration required to connect the network adapter to a network; and a step of registering the selected network adapter and an entered logical network configuration.

The step of receiving this logical network configuration input preferably may be inputs of an IP (Internet Protocol), a DNS (Domain Name System), and a browser specified for the network adapter respectively. When those specified items are entered and registered beforehand so as to be related to location information, it is possible to change (overwrite) the network and the logical network configuration concurrently for the user-specified location.

The network connection registering method of the present invention, in a further aspect, can also accept registered identification information used to identify a network connection to be changed to another (i.e., from one to another), accepting a selected network adapter used in accordance with this identification information, receiving inputs of an IP (Internet Protocol) and a DNS (Domain Name System) specified respectively for the network adapter selected in accordance with this identification information, and receiving an input of a proxy server configuration in accordance with the registered identification information.

In another aspect, the network connection selecting method of the present invention comprises: a step of displaying a list of registered identification information items corresponding to the places to which the computer is possibly moved and used there respectively; a step of receiving the information of a network adapter corresponding to the identification information selected by the user from this displayed list and the network adapter configuration information from the data base; a step of changing a network adapter to another according to the received network adapter information so as to connect the adapter to a network corresponding to the received configuration information; a step of receiving an application program used to connect the adapter to a network corresponding to the selected identification information; and a step of executing the received application program so as to establish the an external communication.

The network connection selecting method of the present invention, in a further aspect, may also store adapter information, which is physical change information, and network configuration information, which is logical change information corresponding to this adapter information in accordance with each of a plurality of network connections, receive a network connection request from the user, change an adapter to another according to the predetermined adapter information selected from the stored information of the adapters in response to a received network connection request, and update the network configuration according to the predetermined network configuration information selected from the stored network configuration information according to this network connection request.

Furthermore, in another preferred embodiment, the present invention provides a network setting-up method used in a computer, comprising: a step of obtaining an identifier used to identify an object to be operatively connected with the computer by scanning of identifiers; a step of selecting an identifier with higher priority from among the plurality of identifiers resulting from the scanning; a step of retrieving a registered profile that includes the identifier resulting from the scanning among a plurality of profiles registered and stored beforehand; and a step of setting up a configuration of a network according to the registered profile resulting from the retrieving.

The network configuration setting-up method of the present invention enables the user to generate information of a registered profile that includes such identifiers as an SSID, a MAC address, etc. used to connect a network, as well as such identification information as location formation to be decided by the user, store the generated information of the registered profile in a data base, read specific registered profile information from among registered profile information stored in this data base according to an identifier, and register priority for each of a plurality of registered profile information items stored in this data base.

Each of the above present inventions may also be taken as programs stored on a computer-readable recording medium so as to be executed by the computer or a program configured so as to enable the computer to execute each of the above functions. The recording medium for storing the above programs may be a CD-ROM or the like and the programs are read by a CD-ROM reader of the computer and stored in, for example, a hard disk of the computer and executed by the computer. Those programs may also be supplied to such computers as notebook PCs via a network by, for example, a program sending device. The program sending device is simply required to have a memory for storing the programs and program sending means for supplying the programs to external via a network.

### BRIEF DESCRIPTION OF THE DRAWINGS

Other aspects, features, and advantages of the present invention will become more fully apparent from the following detailed description, the appended claims, and the accompanying drawings in which:

FIG. 1 is an overall block diagram of a network connection system in an embodiment of the present invention;

FIG. 2 is an example depicting the network connection system in the above embodiment;

FIG. 3 is a table of parameters used to connect a network at each of places;

FIG. 4 is a flowchart of processings for registering a network connection in a network configuration registering unit;

FIG. 5 is a representation of a display screen that prompts the user to enter a location name and select an adapter category (i.e., connection type);

FIG. 6 is a display screen for a list of usable network adapters in a preferred embodiment;

FIG. 7 is a display screen for a selected IP address and a selected DNS in a preferred embodiment;

FIG. 8 is a display screen for setting up an Internet browser in a preferred embodiment;

FIG. 9 is a flowchart of the processing for changing a network connection to another in a preferred embodiment;

FIG. 10 is a list of location names displayed on the network connection changing screen;

FIG. 11 shows a data structure of a registered profile used for wireless connection;

FIGS. 12(A) and 12(B) show a relationship between a network name (SSID) and a location profile at each of a plurality of access points;

FIG. 13 shows a user interface related to a specification of automatic switching between networks;

FIGS. 14(A) and 14(B) show how a network name (SSID) is detected in a preferred embodiment; and

FIG. 15 shows a flowchart of switching between location profiles.

### DETAILED DESCRIPTION OF THE INVENTION

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings

Hereunder, a preferred embodiment of the present invention will be described in detail with reference to the accompanying drawings.

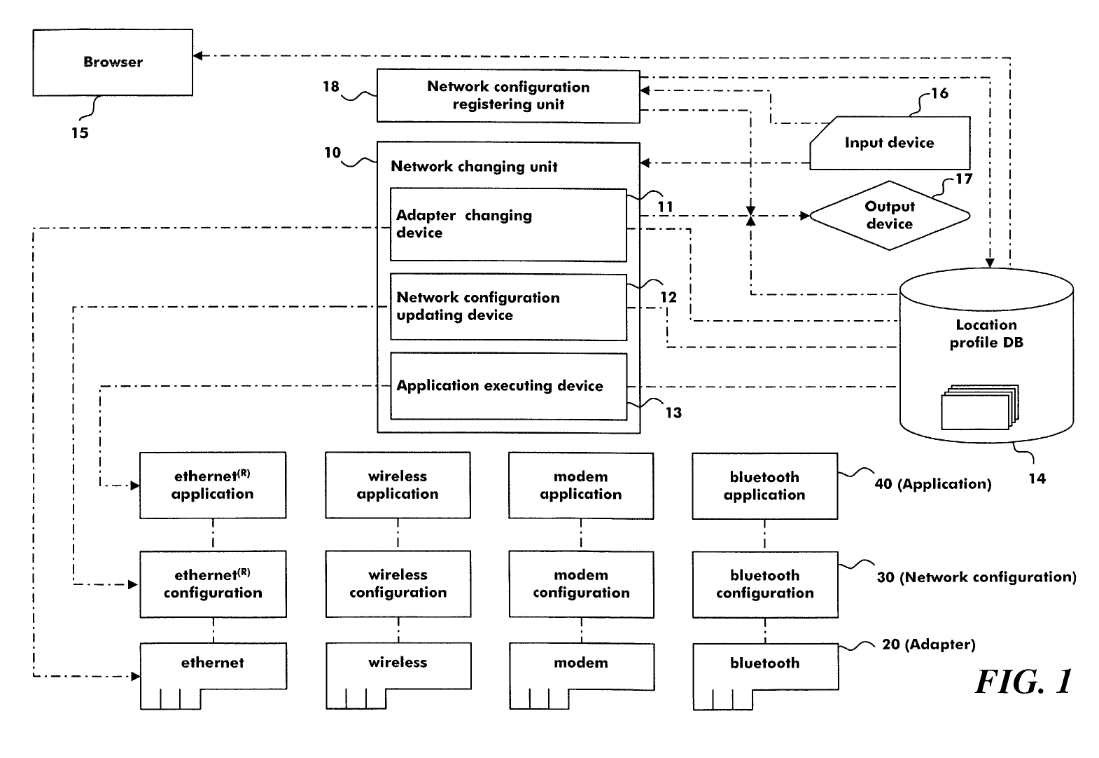

FIG. 1 is an overall block diagram of a network connection system in an embodiment of the present invention. Specifically, FIG. 1 shows a physical or logical configuration of the network connection system employed for a notebook PC (one of portable information apparatuses). In this embodiment, the network connection system is provided with a plurality of physical adapters (network adapters) 20; a plurality of network configurations 30 providing logical network configuration in accordance with the respective adapters 20; and a plurality of application programs 40 required for the network connections in accordance with those adapters 20.

This network connection system is also provided with an output device 17, which is, for example, a liquid crystal display (LCD) used to display a list of location names (to be described later), an input device 16, which is, for example, a mouse used to accept a user's selection of location, etc., and a network changing unit 10 used to receive the input from this input device 16. This network changing unit 10 includes an adapter changing device 11 used to switch an adapter 20 to another, a network configuration updating device 12 used to update a logical network configuration 30, and an application executing device 13 used to execute the application 40. The network connection system also includes a location profile data base (DB) 14 composed of, for example, a hard disk drive (HDD) and used to store location profile information related to each location, as well as a browser (Internet browser) 15 used to connect the Internet and display the contents. Furthermore, the network connection system includes a network configuration registering unit 18 used to register the configuration information of each network. This network configuration registering unit 18 enables network configuration information to be stored in the location profile DB 14.

The adapter 20 is an interface device and it may be a network interface device built in the computer, a network PC card loaded in a PC card slot of the computer, an external network connection board to be loaded in an expansion slot (connected to a bus).

In FIG. 1, some adapters are shown as the adapters 20; an Ethernet® adapter to be connected to the Ethernet®, a wireless card, that is, a connection board (LAN connection board) for connecting the computer to a network via an access point without using a cable, a modem adapter, which is a board corresponding to a modem used to access a network via a telephone line, etc., a bluetooth adapter used to communicate with external by means of the bluetooth, which is a short-range wireless transmission method.

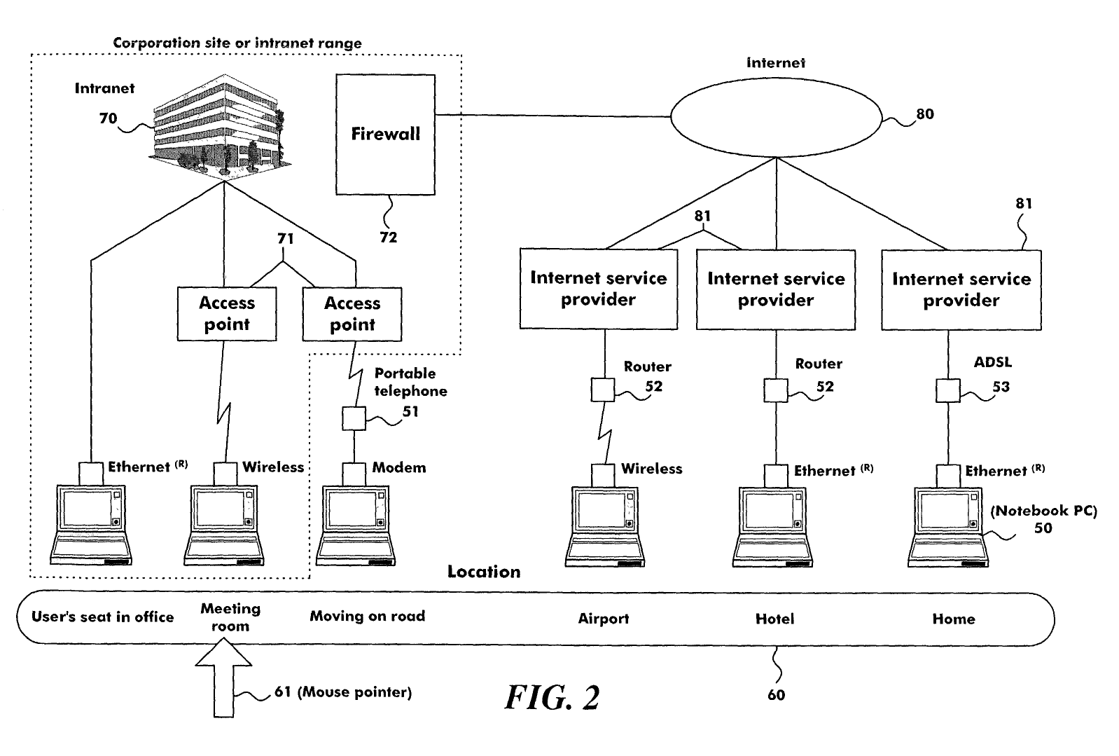

FIG. 2 shows an example for denoting how the network connection system in the present embodiment may be used. In FIG. 2, a notebook PC 50, which is a computer provided with the above network connection system, is moved and used in various locations. The “network connection” in this embodiment includes items set so as to connect the hardware (HW) interface in use to a network, an application program (application 40) required for the network connection, some configuration items for the browser 15, etc.

A change from a network to another in the notebook PC 50 is done by specifying a displayed location 60 with use of, for example, a mouse pointer 61. A system provided with a plurality of network adapters 20 requires the following parameters that must be decided so as to connect a network; “a network adapter (Ethernet®, token, wireless, etc.) used for the communication” and “items (IP, DNS, proxy, etc.) specified for the network and given to the network adapter”. This embodiment employs a concept of “location”, which can be recognized intuitively even by users who are unfamiliar to the setup of detailed network configuration items. This “location” can be specified by the user by using names (identification information) which would be readily identified and more easily remembered.

In FIG. 2, the user's seat in an office, meeting room, moving on road, airport, hotel, and home are shown as location items 60. The user can thus change the registered items of both interface and network connection so as to change the network connection to another only by selecting a preset location name with the mouse pointer 61 at the place where the user exists; the user is not required to make any complicated operation (interface and network connection changes).

In FIG. 2, the system is connected to both an intranet 70 and the Internet 80. Further, a firewall 72 is formed between the intranet 70 and the Internet 80 so as to manage data communication there between. Access points 71 are provided at the site of a corporation or in the range of the intranet 70 enclosed by a broken line. The access points 71 are radio-wave receiving ports of wireless communication with the other end of communication. For example, when the notebook PC 50 is connected to the wireless adapter 20, the PC 50 is connected directly to its access point 71. When the PC 50 is connected to the modem adapter 20, the PC 50 is connected to its access point 71 via the portable telephone 51. When the PC 50 is connected to the Internet 80 without passing through the intranet 70, the PC 50 is connected to the Internet 80 via an Internet service provider 81. The notebook PC 50, when passing through the wireless or Ethernet® adapter 20, also passes through a router 52 so as to be connected to an Internet service provider 81. When passing through the home Ethernet® adapter, the PC 50 is connected to the Internet service provider 81 via an ADSL (Asymmetric Digital Subscriber Line) modem 53.

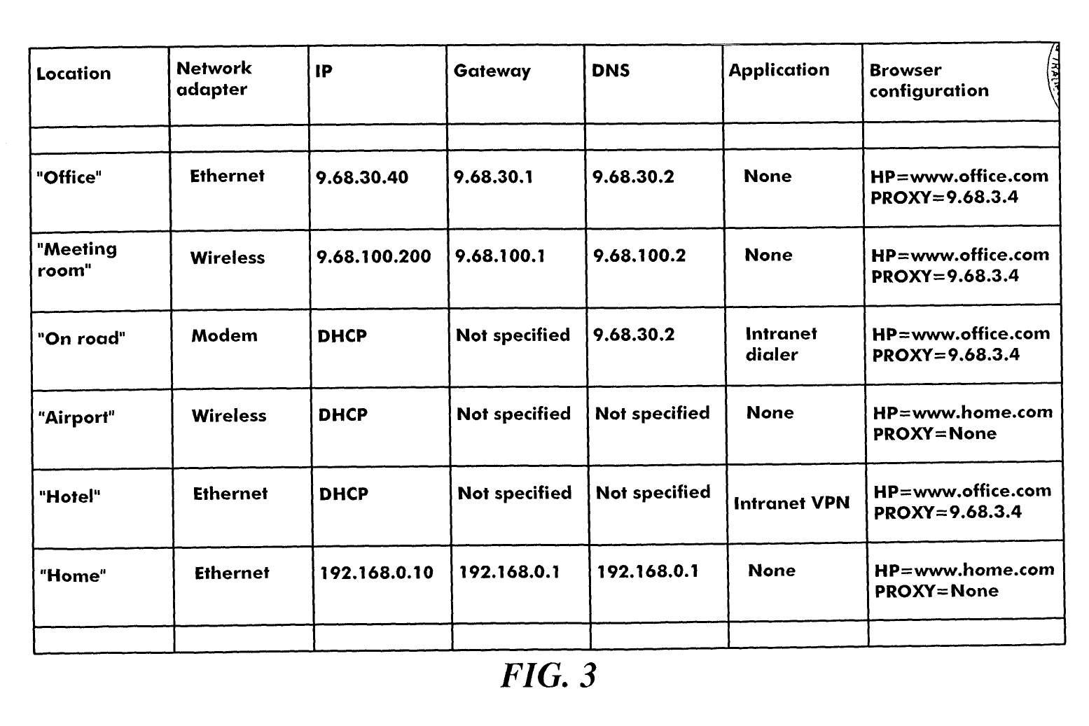

FIG. 3 is a table of parameters to be used for network connection at various places. Those parameters are stored in the location profile DB 14 shown in FIG. 1. In this embodiment, such location identification information items as “office”, “home”, etc. are added to the parameters to be stored in the location profile DB 14. Hereinafter, each network connection example will be described with reference to FIGS. 2 and 3.

The notebook PC 50 accesses the company's intranet 70 via the Ethernet® adapter from the user's seat in the office so as to access the Internet 80 via a proxy server. At this time, for exemplary purposes, the network connection is set so that the IP address (Internet Protocol Address) is specified to 9.68.30.40, the gateway to 9.68.30.1, and the DNS (Domain Name System) server to 9.68.30.2 respectively. The IP address is a figure string equivalent to an address of a computer connected to the Internet 80 and IP packets are to be sent thereto. The gateway is a device for transferring packets to an external network that is not routed explicitly. The gateway IP address must also be specified before the network connection. In addition, the DNS server is provided with a table on correspondence between host names and IP addresses. The DNS server must also be specified before network connection. In order to access the Internet 80 over the firewall 72, proxy.office.com(9.68.3.4) must be specified as a proxy server in the browser 15 and http://www.office.com must be specified for the company's home page (HP) displayed when the browser 15 is started up.

Assume now, for further exemplification, that this notebook PC 50 is connected to the Internet 80 via the intranet 70 and used in a meeting room enabled for wireless communication. In this case, a IEEE802.11b wireless card is used as the adapter 20 and the IP address is specified to 9.68.100.200, the gateway to 9.68.100.1, and the DNS server to 9.68.100.2 so as to specify the network connection.

Next, assume further that the notebook 50 is connected to the intranet 80 via the Internet 70 while the user is moving on a vehicle. In such a case, a modem connected to the portable telephone 51 is used and an intranet dialer provided as standard for the company is started so as to connect the PC 50 to a target network. At this time, it is premised that the IP address is specified to the DHCP (Dynamic Host Configuration Protocol) and no gateway is specified, and the DNS server is specified to 9.68.30.2 respectively.

When this notebook PC 50 is connected to the Internet 80 via a contracted Internet service provider 81 and used at an airport enabled for wireless communication, an IEEE802.11b wireless adapter is specified for the network adapter, the IP address is specified to the DHCP, no gateway is specified, and no DNS server is specified. Because the PC 50 is connected directly to the Internet 80 in this case, there is no need to specify a proxy server. The home page at this time is decided as the user's favorite “http://www.home.com”.

When this notebook PC 50 is connected to the intranet 70 and the Internet 80 via an Internet service provider 81 and used at a hotel, the Ethernet® adapter is specified so as to connect a router 52, then the IP address is specified to the DHCP, no gateway is specified, no DNS server is specified, and the intranet VPN (Virtual Private Network) program is started so as to access the intranet 70 via the Internet 80.

Furthermore, when this notebook PC 50 is connected to the Internet 80 via an Internet service provider 81 and used at home, the Ethernet® adapter is specified so as to connect the ADSL modem 53, then the IP address is specified to 192.168.0.10, the gateway is specified to 192.168.0.1, and the DNS server is specified to 192.168.0.1. No proxy server is specified, since the PC 50 is connected directly to the Internet 80. The home page at this time may be, for example, the user's favorite http://www.home.com.

The location profile DB 14 stores network connection parameters for various locations as described above so as to be identified with location names in this embodiment. As a result, for example, even when the notebook PC 50 is moved from a first place to another place, the user can change a network connection to another only by specifying a simple location; the user is not required to update the network connection items one by one manually.

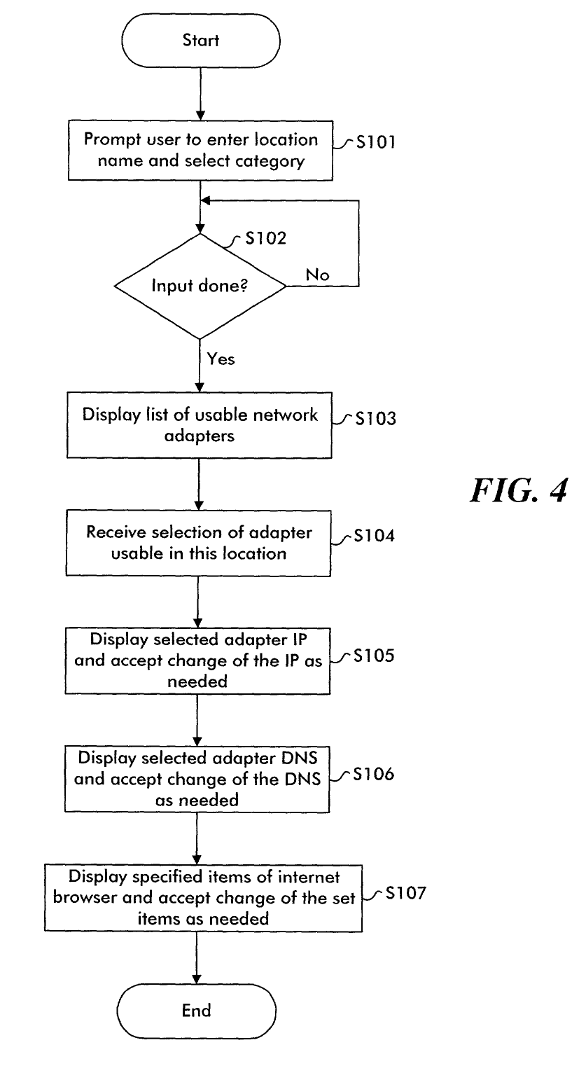

Next, a description will be made for how a network connection is registered with reference to FIGS. 4 through 8. FIG. 4 is a flowchart of processing for registering a network connection with use of the network configuration registering device 18. The network configuration registering device 18 displays a screen on the display device 17 so as to request the user to enter a location name and a category (connection type) selection of an adapter 20 (step 101), then wait for an input from the user via the input device 16 (step 102).

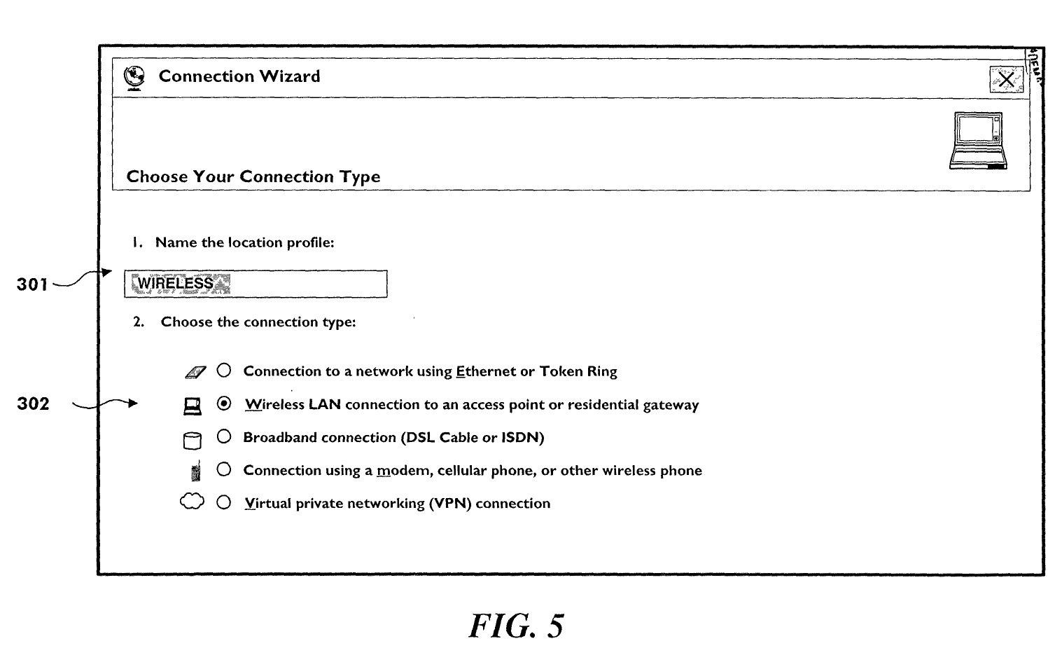

FIG. 5 shows a display screen example in this step 101. In FIG. 5, a location name 301 and categories (types) 302 of the adapter 20 are displayed on the screen. In this example, the wireless LAN category (connection type), the second from the top, is displayed on the screen. While FIG. 5 also shows a default “WIRELESS” for the location name 301, “MEETING ROOM” may be entered, for example.

Then, a list of usable network adapters 20 is displayed on the screen of the display device 17 (step 103) so that the adapter 20 usable in the location is selected by the user from the list (step 104).

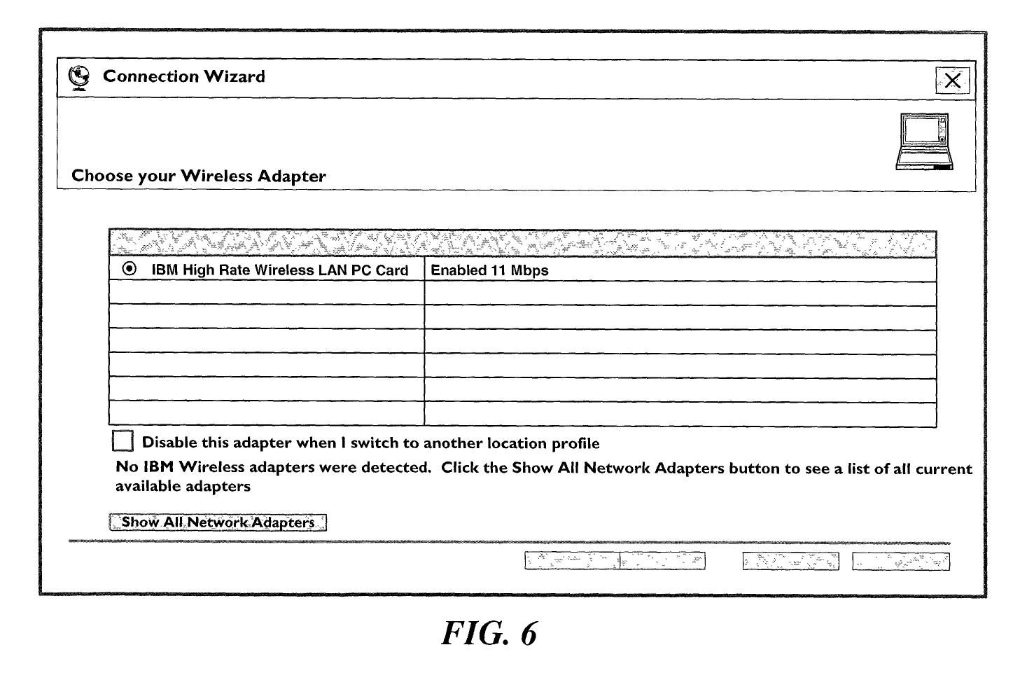

FIG. 6 shows display screen examples in those steps 103 and 104. In FIG. 6, the wireless adapter is selected for the category (connection type) and a list of network adapters 20 usable in the location are displayed. In this example, only one adapter 20 is displayed in the list.

Afterwhich, the network configuration registering device 18 displays the specified IP address of the selected adapter 20 on the screen of the output device 17 so that the user can change the IP address as needed (step 105). The device also displays the DNS item specified for the selected adapter 20 on the screen of the output device 17 so that the user can change the DNS item as needed (step 106).

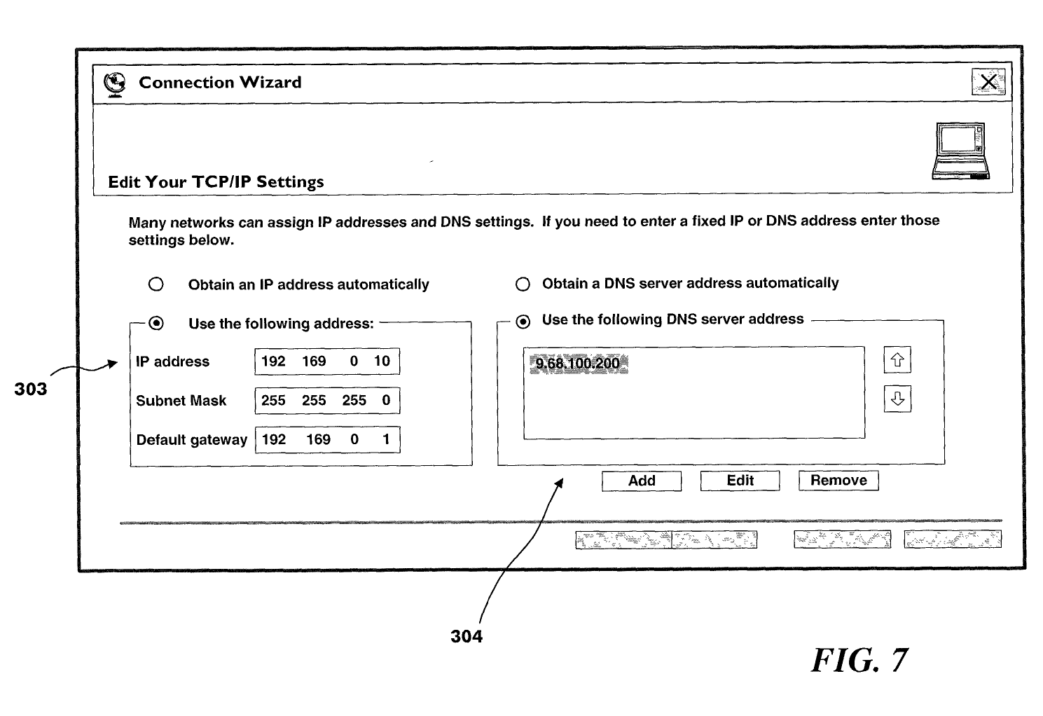

FIG. 7 shows a display example for a selected IP address and a selected DNS item. In FIG. 7, the IP address 303 and the DNS item 304 are shown. When the user wants to change any specified item, the user is requested to operate the input device 16 and select the item on the screen.

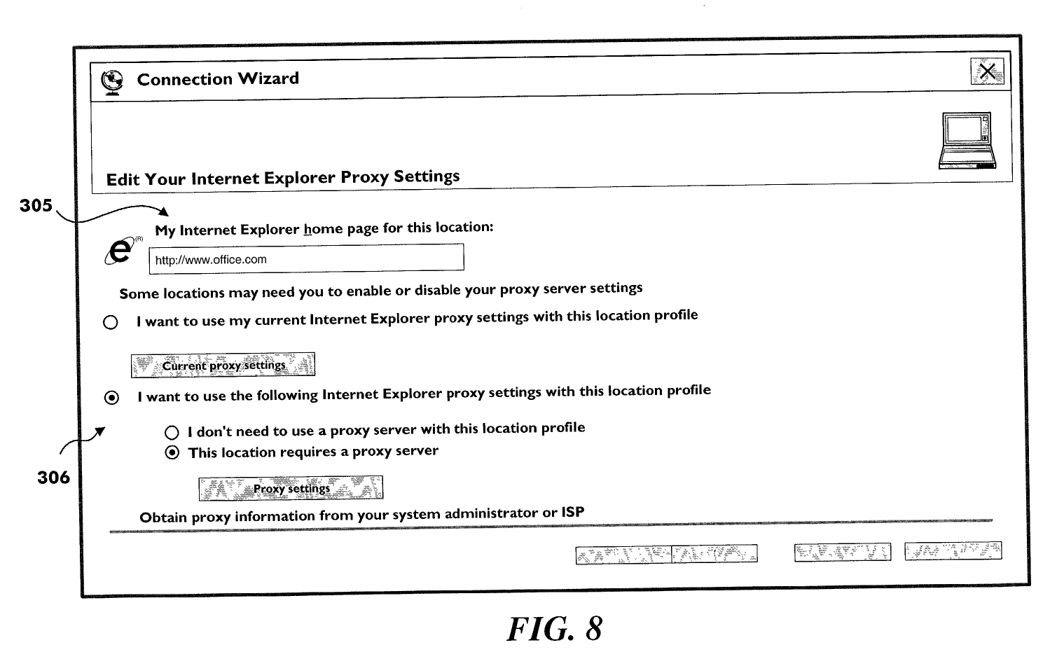

Furthermore, the network configuration registering device 18 displays the specified items of the Internet browser 15 so that the user can change the specified items as needed (step 107). FIG. 8 shows a display screen example for the specified items of the Internet browser 15. Two items are specified for the Internet browser 15; a default home page to be displayed when the Internet browser is started up and a proxy server. In this example, the screen displays specified items of the Internet Explorer (Microsoft Corp.) used as the browser 15.

As described above, this embodiment enables the location profile DB 14 to store the “location” parameters specified by the user and required to connect the PC 50 to a network.

Next, a description will be made for changing a network connection to another in this embodiment.

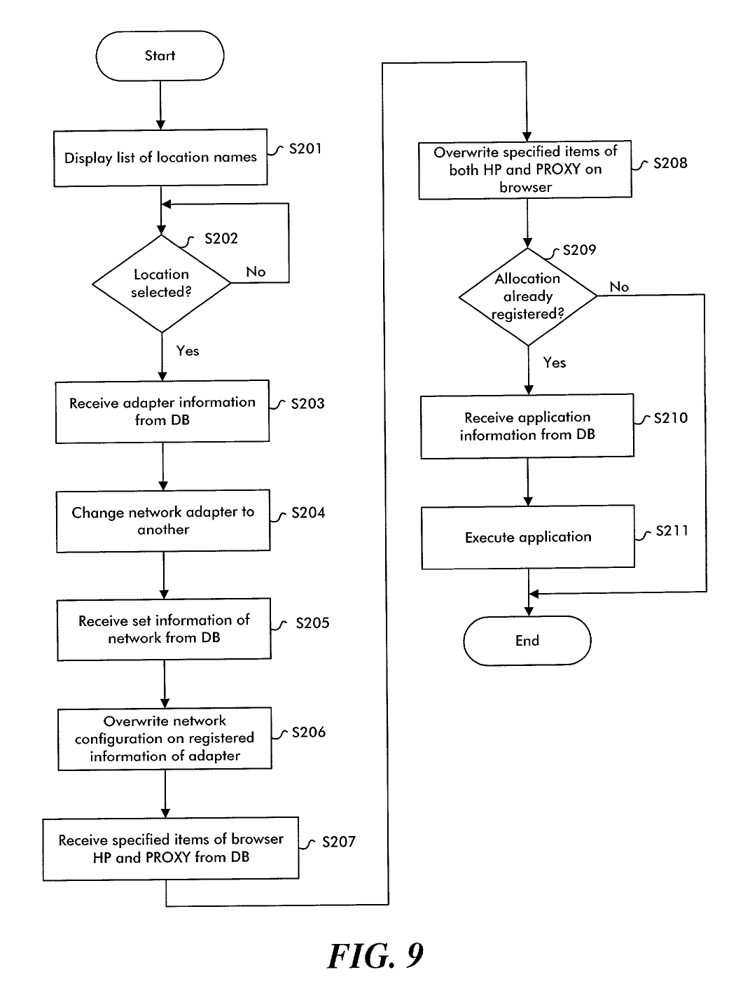

FIG. 9 is a flowchart of the processing for changing a network connection from one connection to another. At first, in the case of the network connection system in this embodiment, a list of location names is read from the location profile DB 14 and displayed on the screen of the output device 17 (step 201).

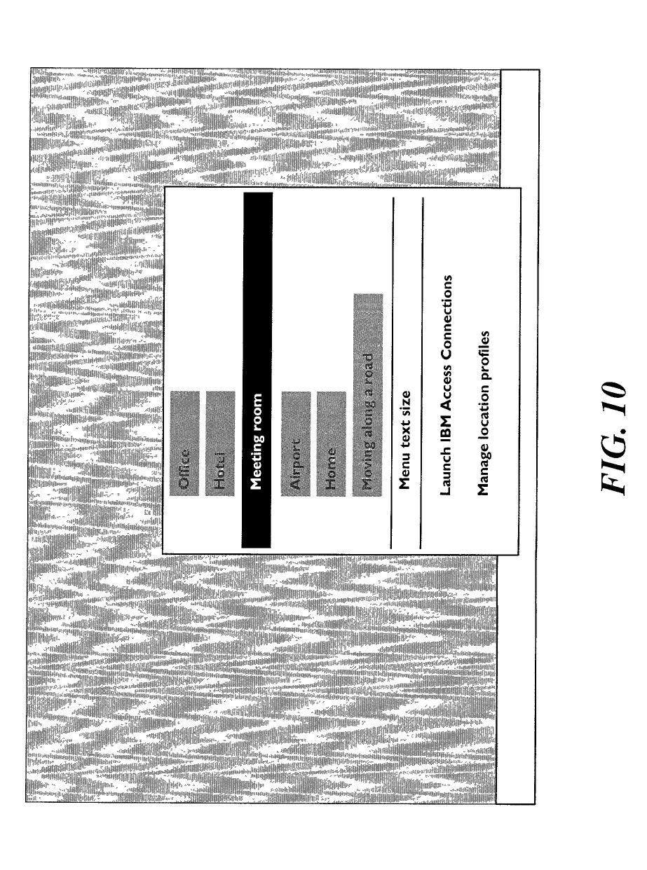

FIG. 10 shows a network connection changing screen on which a list of location names is displayed. In this example, user's seat in office, hotel, meeting room, home, and moving on road are registered as location identification information items. In this example, “meeting room” is selected and its video is reversed. In the example shown in FIG. 10, an explanatory icon is added to the network connection type registered for each location. For example, for moving on road while a modem is used, a telephone mark (icon) is displayed on the screen.

Then, the network changing unit 10 waits for a user's input of selected location via the input device 16 (step 202). When a location is selected, the adapter changing device 11 receives the information of the adapter 20 from the location profile DB 14 (step 203) and changes the network adapter (adapter 20) to a new one (step 204). After this, the network configuration updating device 12 receives the network configuration information from the location profile DB 14 (step 205) so as to overwrite the network configuration in the adapter specifying information (step 206). The network configuration updating device 12 also receive the home page of the browser 15 and the proxy set information from the location profile DB 14 (step 207) so as to overwrite the home page and the proxy specified information in the browser 15 (step 208).

Then, the network changing unit 10 decides whether or not the subject application program is registered (step 209). When the decision is NO, the change processing is ended. When the decision is YES, the application executing device 13 receives application information from the location profile DB 14 (step 210) so as to execute the application program (step 211), thereby terminating the series of the processing. In other words, when the user selects a location, the network changing unit 10 reads all the parameters corresponding to the location so as to change the physical network adapter (adapter 20) and overwrites the logical network configuration. Consequently, the user can connect the target network by one touch.

As described above, conventionally, there has been no means for physically removing any miniPCI Ethernet® adapter built in the subject system nor disconnecting the network cable from any wireless adapter 20. Consequently, for example, when the user moves with a notebook PC 50, the user is always requested to turn on/off the adapter 20. In addition, to connect the same miniPCI Ethernet® adapter of the PC 50 to another network in another location, the user is always requested to update the network configuration manually at each connection time. In this embodiment of the present invention, however, the user is just requested to specify location profiles corresponding to “office”, “home”, “meeting room”, “office in Roppongi”, etc. that are names (identification information items) easy to remember; the user is not requested to specify those configuration items manually. This is why the user can switch a network connection to another easily with use of such the easy-to-remember keywords at different places while making the best use of the portability of the notebook PC 50, which can be carried from a place to another easily.

For example, when the user selects “office”, which is one of the preset location names, the adapter 20 (for example, the miniPCI Ethernet®) is enabled and other adapters are disabled. At the same time, such corresponding parameters as IP address, gateway, DNS, proxy, etc. are specified in accordance with the selected adapter. The user can thus connect the PC 50 to the network specified for the place where the user exists only by clicking the location, which is identification information registered beforehand.

Furthermore, in this embodiment, it is possible to change to same adapter with a plurality of networks even though this function is not presently supported by the Windows^{ò} (Microsoft Corp.). It is also possible to change the specified items of both Internet browser home page and proxy concurrently while they differ between the Internet and each intranet. In addition, it is possible to specify connection parameters for each target network step by step with reference to the wizard guidance. Already-specified items can also be captured and stored and idle network adapters can be disabled (deactivated) so as to suppress wasteful power consumption and extend the battery driving time.

Next, a description will be made for how a network is switched over to another automatically in this embodiment. In this embodiment, for example, a network name (SSID: Service Set Identification) is used as an identifier of an access point and detected by an application program, thereby the configuration of a network such as a wireless LAN is set up automatically.

In this case, at first, the network name (SSID) of the access point is scanned and preferably obtained. Then, it is checked whether or not a registered profile of network that includes the SSID is registered for the location name. When the location name is found, the whole network configuration that includes the wireless setting is updated automatically. This SSID is an identification number used to identify an object, such as an external access point, to be operatively connected to the computer party and the SSID is used as a PIN (Personal Identification Number) for communicating device or nodes to check up each other. Communication between those devices is enabled only when this SSID matches between them. The SSID is validated in each of the infrastructure, 802, and 11AD Hoc modes. In addition to the SSID, a MAC address can be used as an identifier to be scanned. A MAC address is provided with both source and destination address fields in the MAC (Media Access Control) frame. In both source and destination addresses, the number of bits is fixed respectively.

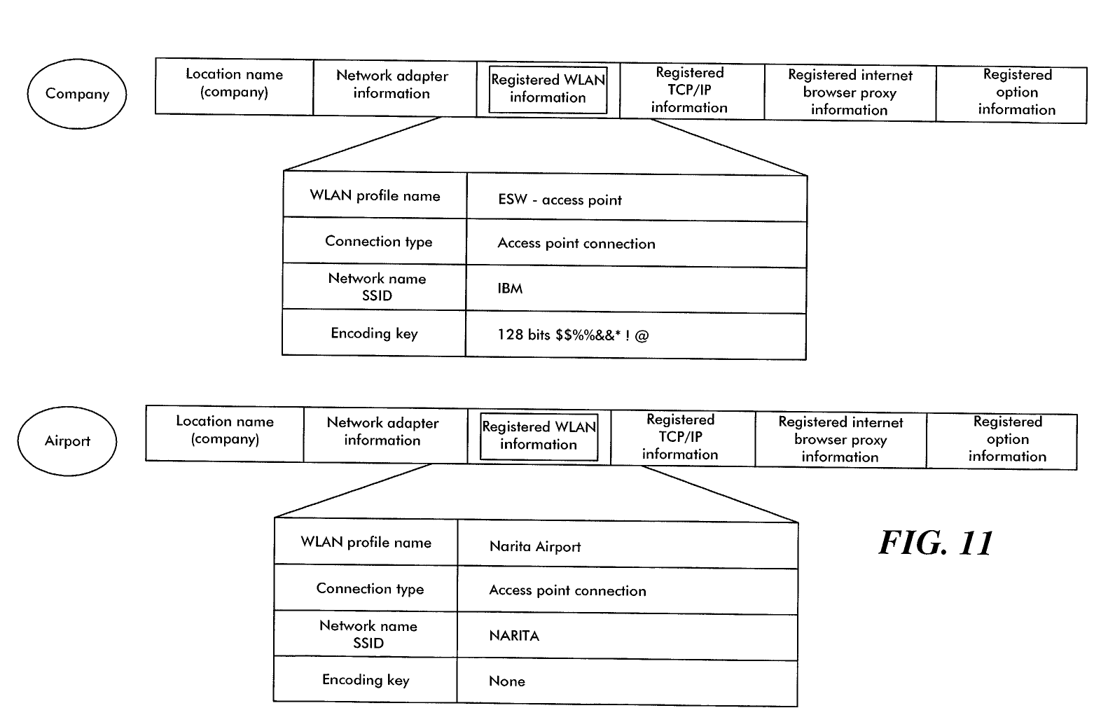

FIG. 11 shows a data structure of a registered profile stored in the location profile DB 14 and used for wireless connection. The contents of the data structure shown in FIG. 11 are described more in detail than those shown in FIG. 3. This registered profile contains location names (company and airport), network adapter information, registered wireless LAN (WLAN) information used to connect an access point, registered TCP/IP information used to connect a server, registered Internet browser proxy information used to connect an Internet browser, and registered option information. The registered option information contains connection information, etc. used to connect such a secured network as a VPN (Virtual Private Network) or the like, for example, even at home. Those information items are preset by the user via a network configuration registering apparatus 18 shown in FIG. 1. For example, the information items are stored in the location profile DB 14 so as to be corresponded to such location names as a company, an airport, etc.

The WLAN (Wireless LAN) configuration information includes a WLAN profile name, a connection type, a network name (SSID) that is an identifier, an encoding key, etc. The network configuration updating apparatus 12 shown in FIG. 1 obtains a network name (SSID) of an access point, for example, at a predetermined place to collate it with the network name (SSID) set in the WLAN configuration information stored in the location profile DB 14. When both network names match in the collation, the user set items included in the location profile as shown in FIG. 11 are updated automatically at a time. Consequently, the user is not required to do any manual operation; the network configuration is set up automatically.

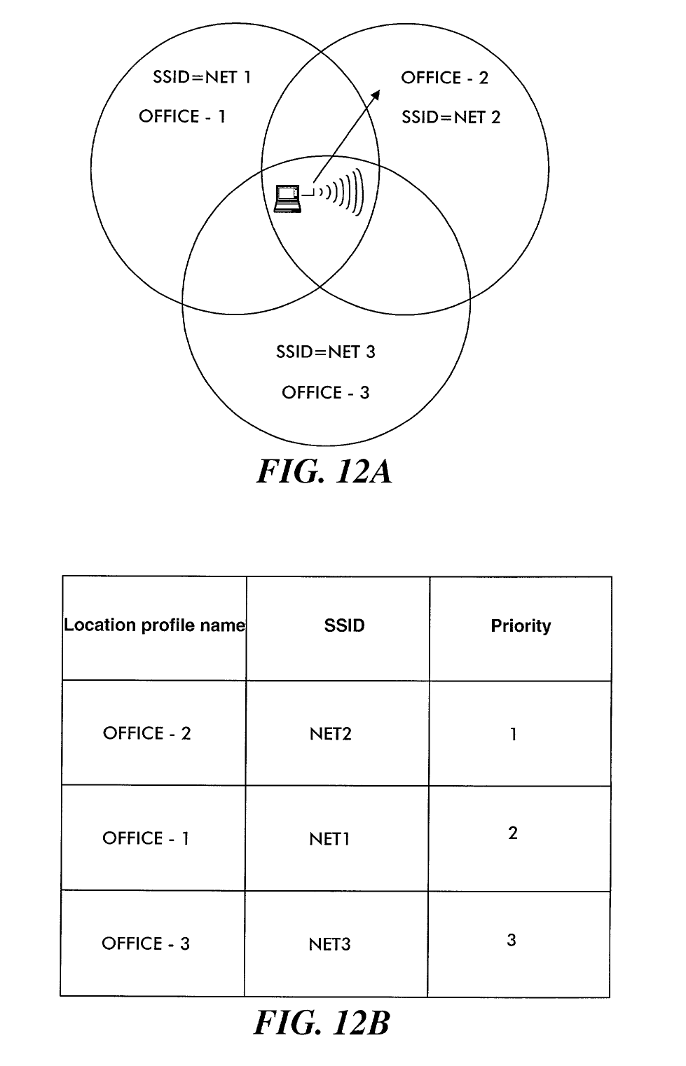

FIGS. 12(A) and 12(B) show a relationship between a network name (SSID) and a location profile at each of a plurality of access points. In this case, a computer receives signals from three places to detect network names while network names are kept sent from a plurality of access points. In the example shown in FIG. 12(A), the computer detects three network names of SSID=NET1, SSID=NET2, and SSID=NET3. When a plurality of identifiers are detected such way, a location name profile is switched over to another having higher priority according to the user specified priority in this embodiment. In other words, in the network configuration updating apparatus 12, an access point with higher priority is set according to the information of the priority table corresponding to each location profile name and each network name (SSID) as shown in FIG. 12(B). The priority as shown in FIG. 12(B) can be changed freely by the subject user.

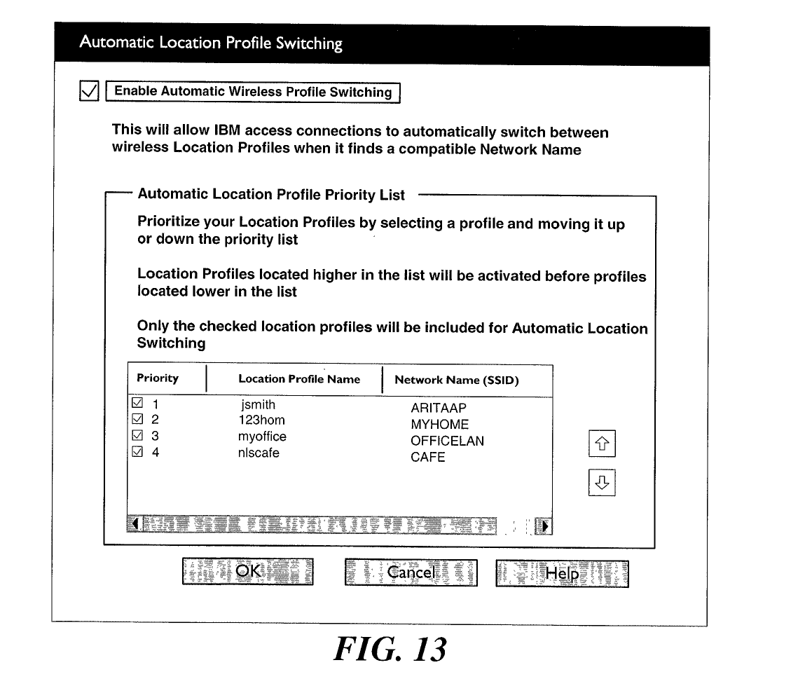

FIG. 13 shows a user interface related to the specification of automatic switching-over. In this case, correspondence between a location profile name and a network name (SSID) is registered and the switching-over required after the registration of priority is specified on the screen as shown in FIG. 13. A location profile name, as shown in FIG. 13, is registered with use of a name decided by the user freely, such as “Narita Airport lounge”, “Home Wireless”, “Company Network”, “nlscafe”, etc. Switching among those items is enabled and the new location profile name can be registered so as to be corresponded to the network name (SSID). When the user does not want to connect this network, however, the user is just required to erase the tick from the priority column shown in FIG. 13. Consequently, automatic connection to the network is avoided even when the identifier is obtained by the scanning.

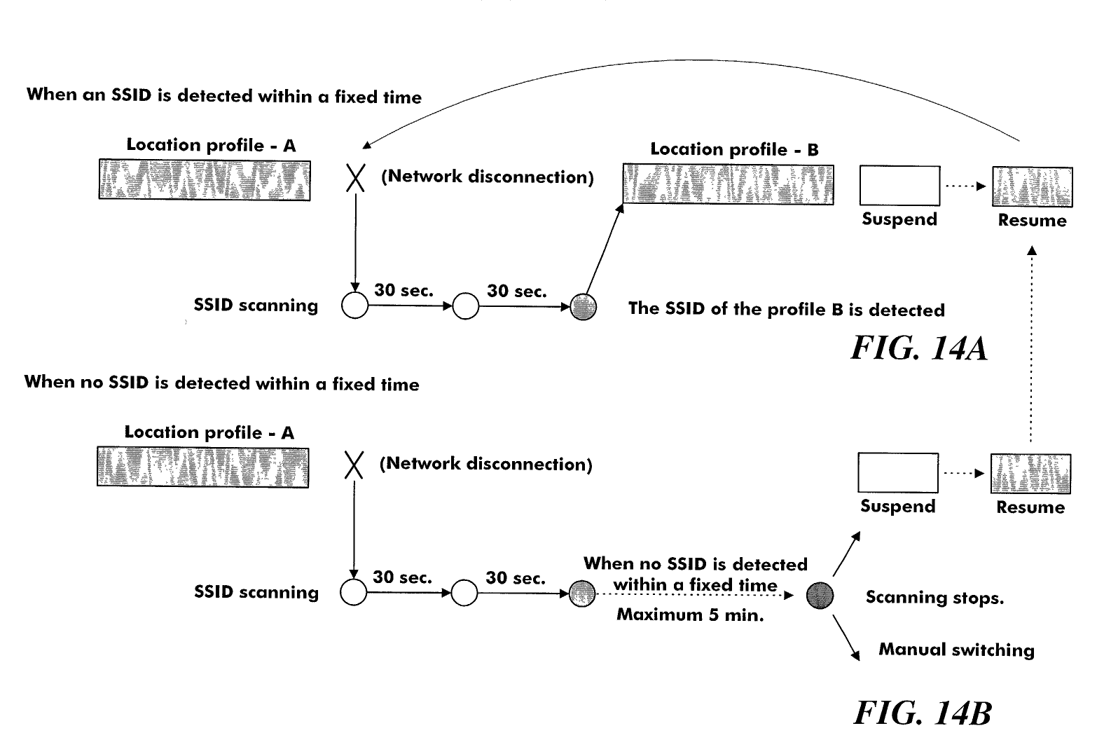

FIGS. 14(A) and 14(B) show how a network name (SSID) is detected. FIG. 14(A) shows a case in which an SSID is detected within a fixed time and FIG. 14(B) shows a case in which the SSID is not detected within the fixed time. In the example shown in FIG. 14(A), the user begins moving out of a state in which the network is connected to a location profile A at, for example, an airport, thereby the network is disconnected once. In a fixed time (ex., 30 sec) after this disconnection from the network, the network name (SSID) is scanned and a network that receives the wave of the identifier is detected in the network configuration updating apparatus 12.

In this example, the SSID of the profile B is detected in 60 sec. After this, when, a laptop PC 50 is covered while the network is connected to the profile B, the PC goes into the suspend state, which is a power saving mode, thereby, for example, a suspended work is restarted by the resume function. After this restarting, another network connection is detected similarly.

IN another aspect, for example, when the user moves to a place where the SSID is not detected after such the disconnection from the network, the scanning stops within a specific time (5 min. in this example) as shown in FIG. 14. Consequently, the battery consumption of the PC 50 can be suppressed. When the user requests a connection to the network in such a state, the user is requested to switch the network connection to another manually. The network configuration setting-up method of the present invention may also be configured so that, when the user moves at the same access point, for example, in the company ground where the connection to a network is enabled while the PC is in the suspend state, scanning is not done just after the restarting. When the specified name is already used, an attempt is made to connect the previous access point. When this connection attempt is rejected, the above-described scanning is done.

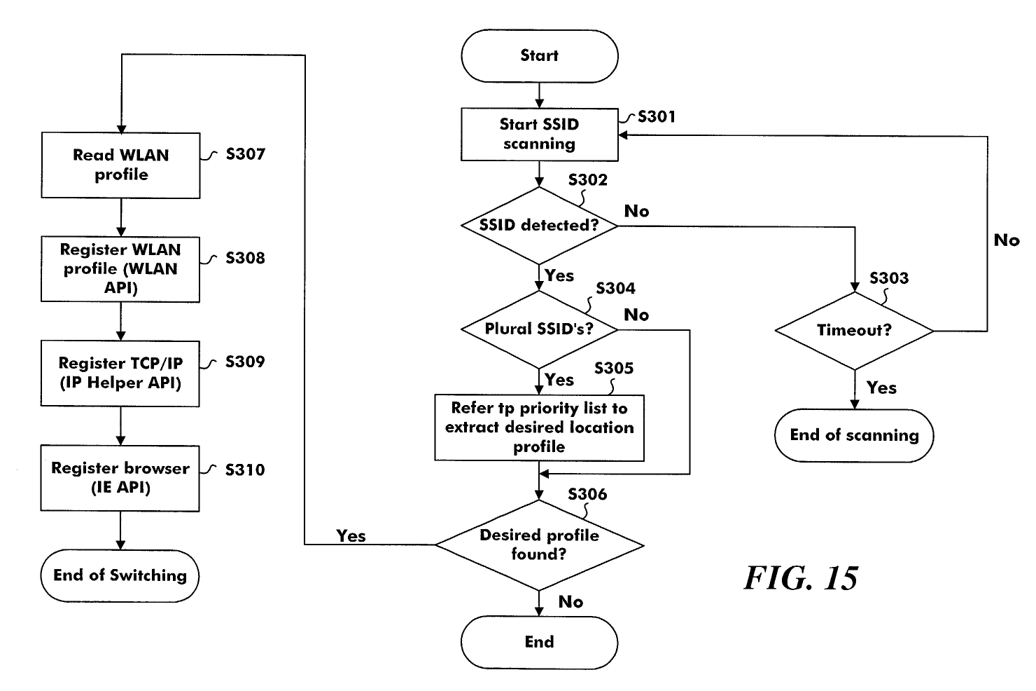

FIG. 15 shows a flowchart of the switching between location profiles. This switching is done by the network configuration updating apparatus 12 shown in FIG. 1. As shown in FIG. 14(A), switching between location profiles starts in response to a message notification of a resume event issued by a network disconnection or suspend state. In this example, at first, scanning of a network name (SSID) that is an identifier, begins (step 301). When no SSID is detected (step 302), it is then decided whether or not a timeout is reached (ex., 5 min.) (step 303). The scanning is continued until the timeout is reached. When the timeout is reached, the scanning ends.

When an SSID is detected in step 302, it is then decided whether or not a plurality of SSIDs are detected (step 304). When a plurality of SSIDs are detected, for example, a priority list is referred to extract the object location profile from the location profile DB 14 of the network configuration updating apparatus 12 (step 305). The priority list is stored in the memory and the location profile DB 14 of the apparatus 12 respectively. At this time, it is also decided whether or not the desired profile exists in the list (step 306). When the desired profile is not found, the switching-over processing is terminated. When there is only an SSID detected in step 304, control goes to step 306 with no operation.

When the desired profile is found in step 306, control goes to a network configuration setting-up work. In other words, the wireless LAN (WLAN) profile set in the corresponding location name is read from the location profile DB 14 (step 307), the WLAN profile is set (WLAN API) (step 308), the TCP/IP is set up (IP Helper API) (step 309), and the browser is registered (IE API) sequentially (step 310), thereby the location profile switching is terminated.

As described above in detail, in the case of the automatic switching-over of the wireless LAN in this embodiment, the wireless network names are scanned when the lap-top PC 50 is booted, when a network disconnection is detected or, when the lap-top PC 50 is resumed from the suspend state. The stored location profile is thus referred to, thereby user's registered items included in the location profile are set at a time automatically. In addition, the network can be switched over to another automatically according to the preset priority even when a plurality of network names are detected.

As described above, according to the present invention, it is possible to change a network to another easily in accordance with the target network configuration in a system provided with a plurality of network adapters. It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. A computer enabled to select a predetermined network connection so as to communicate externally with a system connected to a plurality of networks, said computer comprising:
a setup device for setting up a logical network configuration corresponding to a predetermined network adapter selected by the user from among a plurality of network adapters employed for said system;
an identification information registering device for registering predetermined identification information according to a logical network configuration set up by said setup device; and
a storing device for storing information of said selected network adapter and information of said logical network configuration so as to be related to said identification information registered by said identification information registering device.

2. The computer according to claim 1, wherein said logical network configuration set up by said setup device includes registering of an IP (Internet Protocol), a DNS (Domain Name System) of said network adapter, and an Internet browser.

3. The computer according to claim 2, wherein a proxy server configuration is set up in accordance with said Internet browser's configuration.

4. The computer according to claim 1, wherein said identification information registered by said identification information registering device includes location information of a place where said computer is used.

5. A computer enabled to select a predetermined network connection so as to communicate externally with a system connected to a plurality of networks, said computer comprising:
a connection request receiving device for receiving a network connection request from a user according to predetermined identification information;
an adapter changing device for changing a network adapter to another according to adapter information received from a database and corresponding to said predetermined identification information; and
a network configuration updating device for updating a network configuration in accordance with a change of said network adapter according to said network configuration information corresponding to said predetermined identification information received from said database.

6. The computer according to claim 5, further comprising an application executing device for executing an application program for said network adapter changed by said adapter changing device.

7. The computer according to claim 5, wherein said computer is used by said user at different places, and said predetermined identification information is registered with a location name selected by said user.

8. A computer enabled to select a predetermined network connection so as to communicate externally with a system connected to a plurality of networks, said computer comprising:
a database for storing adapter information, which is physical change information, and network configuration information, which is logical change information corresponding to said adapter information, both adapter information and network configuration information being registered for each of a plurality of said network connections;
a connection request receiving device for receiving a network connection request from a user;
an adapter changing device for changing an adapter to another according to said adapter information received from said database in response to a network connection request received by said connection request receiving device; and,
a network configuration updating device for updating a network configuration according to said network configuration information received from said data base in response to a network connection request received by said connection request receiving device.

9. A computer, comprising:
a device for storing a registered profile that includes network configuration setting-up information corresponding to a predetermined identifier;
a device for scanning an identifier that identifies an object to be operatively connected with said computer; and
a device for reading a registered profile corresponding to said identifier resulting from said scanning by said scanning device to set up the configuration of a network according to the information of said registered profile.

10. The computer according to claim 9, wherein said reading device selects a predetermined registered profile to set up the configuration of said network when a plurality of identifiers are scanned by said scanning device.

11. The computer according to claim 10, wherein said computer further includes priority registering device that registers priority for each of said plurality of identifiers, and wherein said reading device selects said predetermined registered profile according to said priority registered by said priority registering device.

12. A computer, comprising:
a device for generating information of a registered profile that includes an identifier used to connect a network;
a device for storing information of said registered profile generated by said generating device; and
a device for assigning connection priority to a connectable network with use of said selected profile information.

13. The computer according to claim 12, wherein said generating device generates information of said registered profile so as to be corresponded to location information, and said priority assigning device assigns said priority so as to be corresponded to said location information.

14. A portable information apparatus enabled to select a predetermined network connection so as to communicate externally with a system connected to a plurality of networks, said portable information apparatus comprising:
a database for storing information of changeable network adapters and network configuration information corresponding to predetermined identification information;
a display device for displaying a list of said identification information items stored in said database;
an input device for entering a user's selection of specific identification information from said list displayed on said display device; and
a network changing unit for reading both network adapter information and network configuration information from said database according to said user's selection of said specific identification information entered to said input device so as to change a network connection to another.

15. The portable information apparatus according to claim 14, wherein said network changing unit comprises:
an adapter changing device for changing a network adapter to another according to the adapter information received from said data base;
a network configuration updating device for updating a network configuration according to the application information received from said database and browser configuration information; and
an application executing device for executing an application program according to the application information received from said data base.

16. The portable information apparatus according to claim 14, wherein said database stores information of usable network adapters, said network configuration information, and information of said executable application programs corresponding respectively to a location name entered by said user as identification information.

17. A network connection registering method for enabling a computer to select a predetermined network connection so as to communicate externally with a system connected to a plurality of networks, said method comprising the steps of:
receiving an input from the user about location information related to a place where said computer is possibly used;
displaying a list of usable network adapters selected from a plurality of network adapters employed for said system;
receiving a user's selection of a network adapter usable in said location;
receiving a logical network configuration input required for connecting said network adapter to a network; and
registering said selected network adapter and said entered logical network configuration information corresponding to said location information.

18. The network connection registering method according to claim 17, wherein said step of receiving an input of said logical network configuration information receives inputs of network adapter IP (Internet Protocol) information, network adapter DNS (Domain Name System) information, and browser information.

19. A network connection registering method for enabling a computer to select a predetermined network connection so as to communicate externally with a system connected to a plurality of networks, said method comprising the steps of:
receiving registered identification information used by the user to identify a network connection so as to change said network connection to another;
receiving selection of a network adapter in accordance with said registered identification information;
receiving inputs of IP (Internet Protocol) information and DNS (Domain Name System) information of said network adapter selected in accordance with said registered identification information; and
receiving an input of a specified proxy server in accordance with said registered identification information.

20. A network connection selecting method for enabling a computer to select a predetermined network connection so as to communicate externally with a system connected to a plurality of networks, said method comprising the steps of:
displaying a list of identification information items registered corresponding to respective places to which said computer is possibly moved and used;
receiving information of a network adapter corresponding to selected identification information and information of said network adapter in response to a user's selection of said identification information from said displayed list; and
changing a network adapter to another according to said received network adapter information and connecting said changed network adapter to a network according to said received configuration information.

21. The network connection selecting method according to claim 20, wherein said method further includes the steps of:
receiving an application program used to connect a network corresponding to said selected identification information; and
executing said application program so as to establish external communication.

22. A network connection selecting method for enabling a computer to select a predetermined network connection so as to communicate externally with a system connected to a plurality of networks, said method comprising the steps of:
storing adapter information, which is physical change information, and network configuration information, which is logical change information corresponding to said adapter information for each of a plurality of network connections;
receiving a network connection request from a user;
changing an adapter to another according to predetermined adapter information selected from stored adapter information according to said received network connection request; and
updating a network configuration according to predetermined network configuration information selected from stored network configuration information according to said received network connection request.

23. A network configuration setting-up method employed in a computer, said method comprising the steps of:
obtaining an identifier used to identify an object to be operatively connected to said computer by scanning identifiers;
retrieving a registered profile that includes said identifier resulting from said scanning step among a plurality of profiles registered and stored beforehand; and
setting up a configuration of a network according to said registered profile resulting from said retrieving step.

24. The network configuration setting-up method according to claim 23, wherein said method further includes a step of selecting an identifier with higher priority from among a plurality of identifiers resulting from said scanning.

25. A recording medium for storing a program to be read and executed by a computer, wherein said program enables said computer to execute one or more processing steps for:
receiving an input of identification information related to an information of a place to which said computer is possibly moved and used;
displaying a list of usable network adapters selected from a plurality of network adapters employed for a system;
receiving a selected network adapter used according to said entered identification information;
receiving an input of logical network configuration information required so as to connect said selected network adapter to a network; and
registering said selected network adapter and said entered logical network configuration information corresponding to said entered identification information.

26. A recording medium for storing a program to be read and executed by a computer, wherein said program enables said computer to execute one or more processing steps for:
displaying a list of identification information items registered so as to be related respectively to information of a place to which said computer is possibly moved and used;
receiving information of a network adapter corresponding to said selected identification information and configuration information of said network adapter according to selected identification information by a user to the display of said list; and
changing a network adapter to another according to said received network adapter information and connecting said selected adapter to a network according to said received network configuration information.

27. A recording medium that stores a computer readable program enabling said computer to execute one or more processing steps for:
obtaining an identifier used to identify an object to be operatively connected with said computer by scanning identifiers;
retrieving a registered profile that includes said identifier resulting from said scanning among a plurality of profiles registered and stored beforehand; and
setting up a configuration of a network according to said registered profile resulting from said retrieving step.

28. A program for enabling a computer to execute a plurality of functions, said computer being enabled to select a predetermined network connection so as to communicate externally with a system connected to a plurality of networks, wherein said plurality of functions include:
a function for selecting a predetermined network adapter from among a plurality of network adapters employed for said system so as to set up a logical network configuration corresponding to said selected network adapter;
a function for specifying predetermined identification information so as to select said network adapter and set up said logical network configuration; and
a function for storing information of said selected network adapter and said logical network configuration corresponding to said set up identification information.

29. A program for enabling a computer to execute a plurality of functions in a system connected to a plurality of networks, said computer being enabled to select a predetermined network connection so as to communicate externally, wherein said plurality of functions include:
a function for receiving a network connection request from the user according to predetermined identification information;
a function for changing an adapter to another according to the adapter information received from said data base and corresponding to said predetermined identification information; and
a function for updating a network configuration according to the network configuration information received from said database and corresponding to said predetermined identification information.

30. The program according to claim 29, wherein said program enables said computer to further execute a function for executing an application program corresponding to said changed adapter.

31. A program for enabling a computer to execute:
a function for obtaining an identifier used to identify an object to be operatively connected with said computer by scanning identifiers;
a function for retrieving a registered profile that includes said identifier resulting from said scanning among a plurality of profiles registered and stored beforehand; and
a function for setting up a configuration of a network according to said registered profile resulting from said retrieving.

32. The program according to claim 31, wherein said program further enables said computer to execute a function for selecting an identifier with higher priority from among a plurality of identifiers resulting from said scanning.

33. A program for enabling a computer to execute:
a function for generating information of a registered profile that includes an identifier used to connect a network;
a function for storing said generated information of said registered profile in a data base; and
a function for reading specific information of said registered profile according to said identifier, selected from among information of said profile registered and stored in said database.

34. The program according to claim 33, wherein said program further enables said computer to execute a function for registering priority set for each of said plurality of profile information items registered and stored in said data base.

35. The program according to claim 33, wherein said function for generating information of said registered profile generates information of said registered profile that includes identifier information that can be decided by a user.
